(19) United States
(12) Patent Application Publication
(10) Pub. No.: US 2020/0360860 A1
(43) Pub. Date: Nov. 19, 2020

(54) SYSTEM AND METHOD FOR EXTRACTING IONS WITHOUT UTILIZING ION EXCHANGE

(71) Applicants: Research Foundation of the City University of New York, New York, NY (US); RIJKSUNIVERSITEIT GRONINGEN, Groningen (NL)

(72) Inventors: Mark N. Kobrak, Staten Island, NY (US); Francesco Picchioni, Groningen (NL)

(21) Appl. No.: 16/983,650

(22) Filed: Aug. 3, 2020

Related U.S. Application Data
(63) Continuation-in-part of application No. PCT/US2019/016244, filed on Feb. 1, 2019.
(60) Provisional application No. 62/625,030, filed on Feb. 1, 2018.

(51) Int. Cl. B01D 61/24; B01J 20/28; B01J 20/26; B01D 61/02; B01D 61/14; C02F 1/44

(52) U.S. Cl. CPC B01D 61/243; B01J 20/28047; B01J 20/261; C02F 2101/20; B01D 61/027; B01D 61/147; C02F 1/44; B01J 20/262

(57) ABSTRACT

A system for extracting ions from an aqueous solution without utilizing ion exchange. A semi-permeable membrane with 0.1 to 1000 nm diameter pores separates an aqueous salt solution from a chelating gel. The gel has un-crosslinked polymer (e.g. 1-10% by weight) and the balance water. The semi-permeable membrane lets ions diffuse into the chelating gel where the ions become trapped. The gel has a molecular weight that prevents its diffusion through the semi-permeable membrane.

### CROSS-REFERENCE TO RELATED APPLICATIONS

This application claims priority to and is a continuation-in-part of International Patent Publication PCT/US2019/016244 (filed Feb. 1, 2019) which is a non-provisional of U.S. Patent Application 62/625,030 (filed Feb. 1, 2018), the entirety of which are incorporated herein by reference.

### BACKGROUND OF THE INVENTION

The subject matter disclosed herein relates to the extraction of metal ions from aqueous solutions in a liquid-gel separation process. Nano- and microporous-membranes, such as dialysis membranes, have long been used for separations in medicine and in biochemistry. They represent a selective membrane that passes solutes based on their molecular weight (i.e. size), and dialysis membranes with a range of molecular weight cutoffs (MWCOs) are commercially available. Living cells, viruses; and proteins and other biomacromolecules are unable to pass through these membranes, while smaller molecules (water, simple sugars, etc.) move freely. This is a phenomenon that is used to create the artificial kidney (“dialysis machine”) used in medicine as well as various other schemes for the study and processing of biomolecules.

The removal of metal ions from aqueous solutions is useful in a variety of industrial environments including water purification and treatment, metal recovery and a variety of other applications. Conventional methods use metal-ion exchange technology to replace one ion with a different ion, thereby allowing for the removal of a target metal ion. While this technology is suitable in some environments it is not applicable in all situations.

Conventional approaches to metal extraction use either a liquid-liquid solvent extraction or an ion exchange approach based on adsorbing metal ions onto chemically-modified solid surfaces. The former can lead to contamination of the aqueous phase by components of the nonaqueous phase, while the latter can require extensive effort to fabricate the surface, which may be degraded through repeated use. An improved method of extracting metal ions is therefore desirable.

The discussion above is merely provided for general background information and is not intended to be used as an aid in determining the scope of the claimed subject matter.

### BRIEF DESCRIPTION OF THE INVENTION

A system for extracting ions from an aqueous solution without utilizing ion exchange. A semi-permeable membrane with 0.1 to 1000 nm diameter pores separates an aqueous salt solution from a chelating gel. The gel has an un-crosslinked polymer (e.g. 1-10% by weight) and the balance water. The semi-permeable membrane lets ions diffuse into the chelating gel where the ions become trapped. The chelating gel has a molecular weight that prevents its diffusion through the semi-permeable membrane.

In a first embodiment, a system for extracting ions from an aqueous solution without utilizing ion exchange is provided. The system comprising: a semi-permeable membrane comprising pores with an average diameter between 0.1 nm and 1000 nm; an aqueous solution comprising a salt with ions, the aqueous solution being disposed on a first side of the semi-permeable membrane; a chelating gel disposed on a second side of the semi-permeable membrane which is opposite the first side, wherein the chelating gel comprises an un-crosslinked polymer.

In a second embodiment, a method for extracting ions from an aqueous solution without utilizing ion exchange is provided. The method comprising: disposing an aqueous solution on a first side of a semi-permeable membrane, the aqueous solution comprising a salt with ions; disposing a chelating gel on a second side of the semi-permeable membrane which is opposite the first side, wherein the chelating gel comprises an un-crosslinked polymer; waiting a predetermined period of time to permit at least some of the ions to pass through the semi-permeable membrane and become entrapped within the chelating gel; separating the chelating gel from the semi-permeable membrane, thereby extracting the ions.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic diagram of one system for extracting ions from an aqueous solution without utilizing ion exchange;

FIG. 2 is a schematic diagram of another system for extracting ions from an aqueous solution without utilizing ion exchange;

FIG. 3 is a graph showing calcium removal as a function of different polymers;

FIG. 4 is a graph showing sodium removal as a function of different polymers;

FIG. 5 is a graph showing cadmium removal as a function of different polymers;

FIG. 6 is a graph showing calcium removal changing as a function of initial concentration;

FIG. 7 is a graph showing cadmium removal changing as a function of initial concentration;

FIG. 8 is a graph showing calcium removal as a function of cadmium concentration;

FIG. 9 is a graph showing cadmium removal as a function of calcium concentration;

FIG. 10 is a graph showing fraction of ions removed as a function of polymer concentration;

FIG. 11 is a graph showing the effect of calcium removal on sodium concentration;

FIG. 12 is a graph showing the fraction of calcium removed by a chelating gel and a polymeric fluid.

### DETAILED DESCRIPTION OF THE INVENTION

This disclosure generally pertains to the use of semi-permeable membranes in conjunction with chelating agents. The disclosure specifically pertains to the use of such a system to remove metal ions from an aqueous solution without using ion exchange technology. The metal ions pass through a semi-permeable membrane and contact a chelating agent to form a complex. The complex is too large to pass back through the semi-permeable membrane. This configuration permits the removal of the metal ions without the use of ion exchange technology. The disclosed approach dramatically reduces the risk of contamination of the aqueous phase while avoiding the need for the use of a solid surface.

Metal ions, and their solvated complexes, are sufficiently small that they may move freely through dialysis membranes. However, chelating agents capable of binding metals may be synthesized such that they are too large to pass through the membrane, meaning that they may be contained within a bag or a tube that is surrounded by a metal-containing solution. In these circumstances, metal ions will diffuse through the membrane and bind to the chelating agent, immobilizing them.

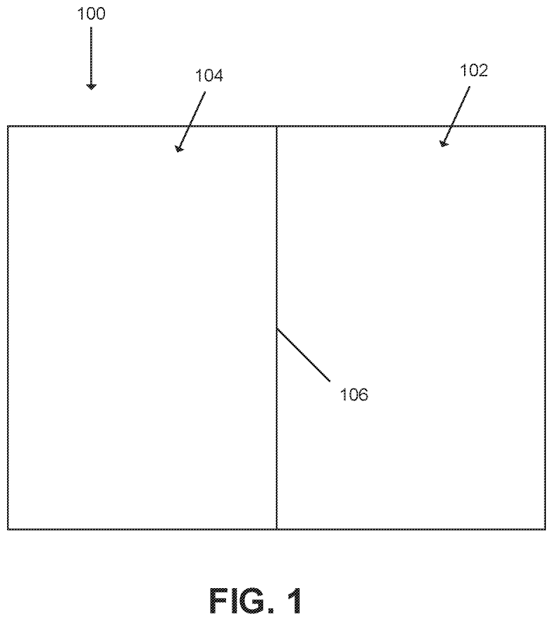

FIG. 1 depicts a system 100 that comprises an aqueous solution 102 that comprises metal ions. The aqueous solution 102 is separated from a chelating gel 104 by a semi-permeable membrane 106.

The aqueous solution may comprise metal ions such as calcium ions, cadmium ions, copper ions, nickel ions, magnesium ions, sodium ions, lithium ions, potassium ions, or other soluble metal ions.

The semi-permeable membrane 106 may comprise an organic membrane such as cellulose or an inorganic membrane such as alumina-based materials. The semi-permeable membrane has pores with an average diameter between 0.1 nm and 1000 nm. In one embodiment, the pores have an average diameter between 0.1 nm and 500 nm. The semi-permeable membrane 106 is water insoluble.

The chelating gel 104 may comprise a polymeric gel such as a polyacrylamide gel. A gel is defined as a non-fluid polymer network that is expanded throughout its volume by a fluid (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. The chelating gel 104 is generally between 1% and 10% polymer, by weight, with the balance water. In one embodiment, the chelating gel 104 is between 1-6% polymer, by weight. The chelating gel 104 comprises a polymer that is un-crosslinked such that the polymer is water soluble (at least 0.1%, by weight, in pure water at room temperature). Crosslinked polymers are not water soluble. Contrary to prior art, the disclosed technology relies on the use of water-soluble un-crosslinked polymers in the form of a gel as the absorbing agent for ions. The absence of any chemical crosslinking is highly desirable in this application and provides a homogeneous condition for adsorption. At the same time contamination of the polymer from the adsorbent phase to the extracted phase is avoided by the use of the porous membrane. Surprisingly the polymeric gel used in this condition is able to adsorb and retain ions in the absence of ion-exchange. In one embodiment, the polymer gel possesses a minimum viscosity of 10,000 centipoise at some range of compositions within the 1% to 6% weight composition noted above. This viscosity is measured under the operating conditions (e.g. temperature, etc.) that the extraction occurs. The chelating gel 104 has an average molecular weight that is related to the average diameter of the pores of the semi-permeable membrane 106 given by equation (1):

Molecular weight_{avg}≥1611×(average pore diameter)^{1.724} (1)

wherein the molecular weight is in Daltons and the pore diameter is given in nanometers. In one embodiment, the chelating gel 104 is ion-free prior to extraction of the metal. In one embodiment, the average molecular weight is at least 10 times the value of 1611×(average pore diameter)^{1.724}.

Chelating gels have numerous advantages over polymeric solutions. For example, a wide range of high-molecular weight polymers form gels, whereas only a small subset of high-molecular weight polymers are soluble in water. Further, soluble polymers often require hydrophilic substituents such as sulfonyl groups that interact strongly with water but are poor Lewis acids for chelating metals. A soluble polymer must contain a significant number of such substituents in place of more strongly chelating substituents, undermining its capacity to bind metals.

Examples of suitable polymers include a polyacrylate, a polyacrylamide (including a partially hydrolyzed polyacrylamide and a sulfonated polyacrylamide), a polycarbonate, a polyacrylic acid, a polysaccharide, a polyvinyl acetate, or other polymers with Lewis base substituents. Additional choices for chelating gels include oligomers or polymers, either natural or artificial, that are known to coordinate with the metal of interest. Such species may be prepared with sufficiently high molecular weights such that they are unable to pass through the dialysis membrane, at least for membranes possessing an appropriately-chosen MWCO (see equation (1)). The list of candidate extraction agents of this type includes ionic or neutral oligomeric or polymeric systems, present as gels.

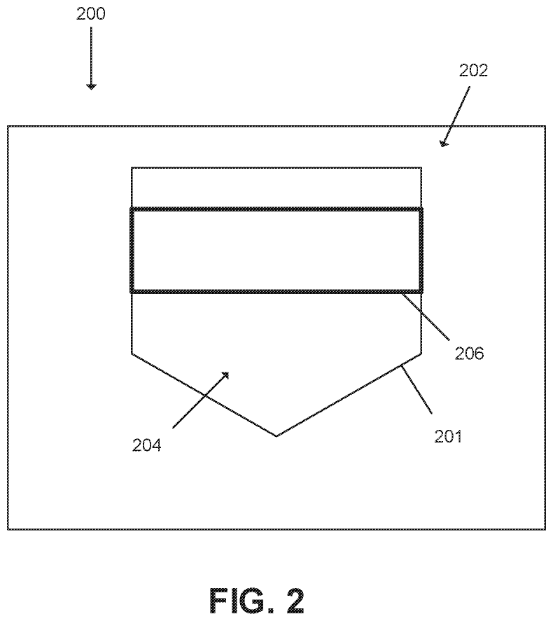

FIG. 2 depicts a system 200 that comprises an aqueous solution 202 that comprises metal ions. A chelating gel 204 is contained within a container 201 (such as a PUR-A-LYZER™ Midi Dialysis vial) with a semi-permeable membrane 206. In one such example, the chelating gel 204 had a volume of 0.7 mL and the aqueous solution 202 has a volume of 40 mL.

The container 201 was filled with ultrapure water to dissolve possible contaminants. After 5-10 minutes the water was removed and about 0.7 g of the chelating gel 204 (2 w %) was injected in the tube. The exact mass was weighed. The chelating gel 204 was a polyacrylamide polymeric gel that is commercially produced by SNF Floerger. The following polyacrylamide polymers were used: Flopaam 3630S (SNF); Flopaam 3130S (SNF); ALP 99 VHM (SNF); AN 125 VLM (SNF); SAV 10 (SNF). The polymers are characterized in Table 1.

TABLE 1

| Polymer | |
|---|---|
| tradename | Polymer |
| FL 3630 S | Partially hydrolysed polyacrylamide gel, |
| | average molecular weight 20 million Daltons, |
| | degree of hydrolysis 25-30%. |
| FL 3130 S | Partially hydrolysed polyacrylamide gel, |
| | average molecular weight 2 million Daltons, |
| | degree of hydrolysis 25-30% |
| ALP 99 VHM | Polyacrylic acid, molecular weight |
| | distribution unknown. |
| AN 125 VLM | Sulfonated polyacrylamide gel, |
| | average molecular weight 2 million |
| | Daltons, sulfonation ~25% by mole number. |
| SAV 10 | Partially hydrolysed polyacrylamide gel, |
| | average molecular weight |
| | 3-8 million Daltons. |

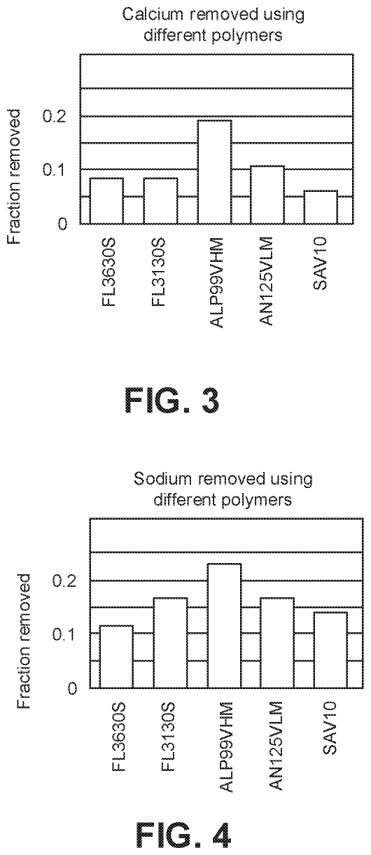

The filled container 201 was subsequently placed in a previously prepared aqueous solution 202. After 22 hours at room temperature (about 22° C.), the aqueous solution 202 was analyzed by atomic absorption. In one embodiment, the system is allowed to stand for at least 10 hours. In some embodiments, an upper time limit (e.g. 48 hours) may be imposed to increase throughput. The results are depicted in FIGS. 3-5.

FIG. 3 depicts the fraction of calcium removed as a function of different chelating gels 204. The initial concentration of calcium ions was 450 mg per L (from a CaCl₂.2H₂O solution). All polyacrylates removed at least 5% of the calcium ions with ALP99VHM removing almost 20%.

FIG. 4 depicts the fraction of sodium removed as a function of different cheating gels 204. The initial concentration of sodium ions was 575 mg per L (from a NaBr solution). All polyacrylates removed at least 10% of the sodium ions with ALP99VHM removing between 20-25%.

FIG. 5 depicts the fraction of cadmium removed as a function of different cheating gels 204. The initial concentration of cadmium ions was 900 mg per L (from a CdCl₂ solution). All polyacrylates removed at least 10% of the cadmium ions with ALP99VHM removing between 30-40%.

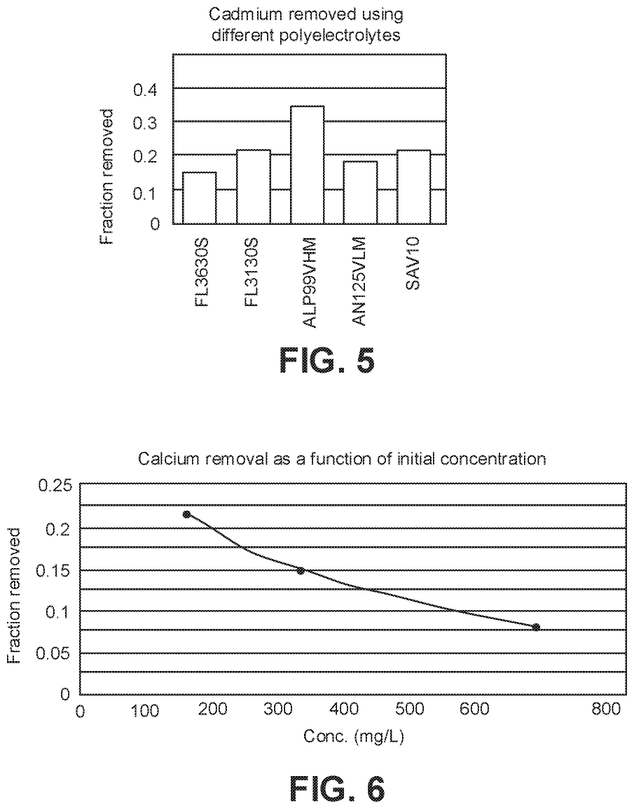

FIG. 6 depicts the fraction of calcium removed as a function of the initial calcium concentration. The concentration specified represents mass of calcium ions per volume prior to the start of the extraction. The procedure is given under “methods.” At lower concentrations (e.g. less than 300 mg per L) more than 15% of the calcium was removed. The fraction that was removed decreased as the initial concentration increased. For example, at an initial concentration of 700 mg per L about 8% of the calcium was removed. In one embodiment, the system is used on an aqueous solution that has less than 1000 mg per L of calcium.

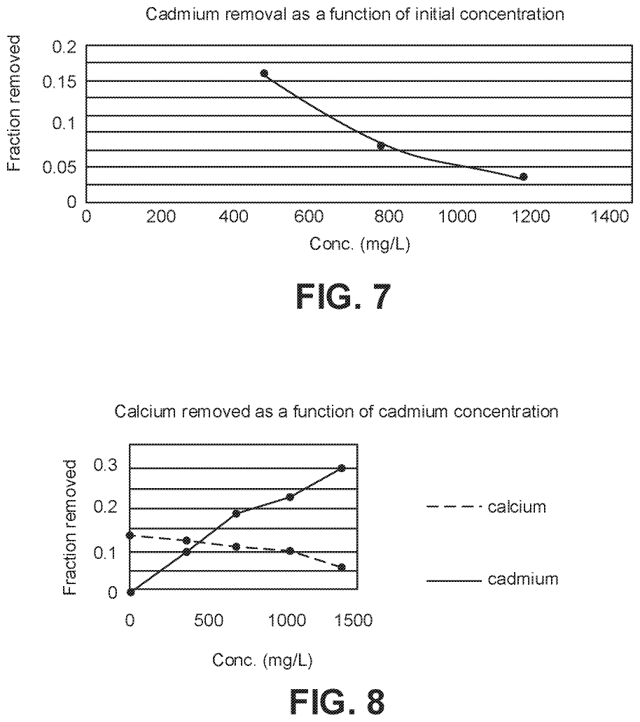

FIG. 7 depicts the fraction of cadmium removed as a function of the initial calcium concentration. The concentration specified represents mass of cadmium ions per volume prior to the start of the extraction. The procedure is given under “methods.” At lower concentrations (e.g. about 500 mg per L) more than 15% of the cadmium was removed. The fraction that was removed decreased as the initial concentration increased. For example, at an initial concentration of 1200 mg per L less than 5% of the cadmium was removed. In one embodiment, the system is used on an aqueous solution that has less than 1000 mg per L of cadmium.

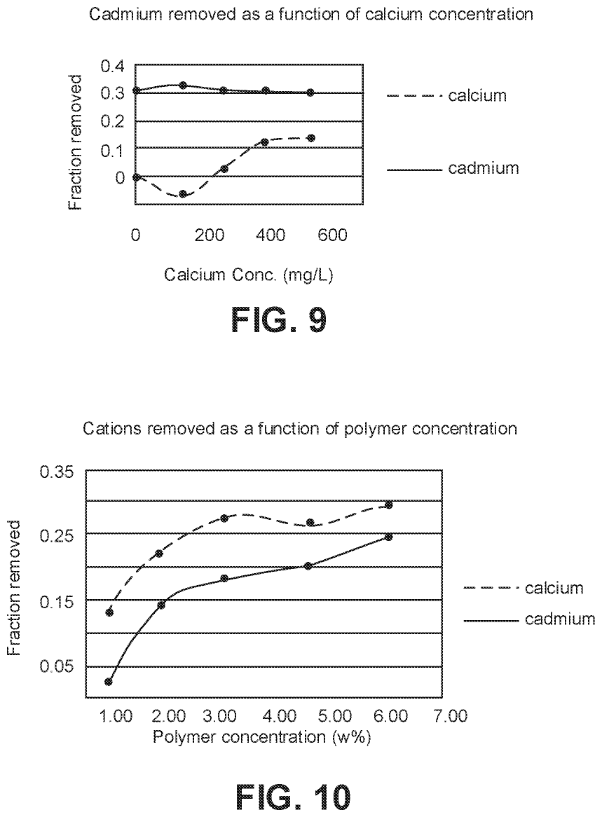

The influence of the presence of other metal ions on the absorption of the target metal ion was tested. The results are displayed in FIGS. 8-9. They demonstrate that for an increasing cadmium concentration, the removal of calcium decreases, while the opposite does not hold.

FIG. 8 is a graph depicting calcium removal as a function of cadmium concentration. The procedure followed is given under “methods,” with the initial aqueous solution 202 prepared as a mixture of calcium chloride and cadmium chloride at the concentrations specified. The initial calcium concentration was 500 mg of calcium ions per L and the removal fraction is depicted on the y-axis. As the cadmium concentration (x-axis, mass of cadmium ions per volume of solution) increased, the fraction of calcium that was removed decreased from about 15% (no cadmium) to about 6% (1500 mg per L cadmium).

FIG. 9 is a graph depicting cadmium concentration as a function of calcium concentration. The procedure followed is that given under “methods,” with the initial aqueous solution 202 prepared as a mixture of calcium chloride and cadmium chloride at the concentrations specified. The initial cadmium concentration was 1500 mg cadmium ion per L of solution. The initial calcium concentration is given on the x-axis (as mass of calcium ion per volume of solution). The cadmium removal was not dependent on the concentration of calcium present. The slight negative value for the calcium fraction removed represents experimental error; no calcium is observed to be removed in this specific experiment (corresponding to the [Ca²⁺ (aq)]=137 mg/L datapoint) within the margin of error of the experiment.

FIG. 10 is a graph depicting the fraction of metal ions removed as a function of the concentration of chelating gel. The procedure outlined under “methods” was followed, with separate experiments for calcium and cadmium carried out (i.e. the two types of ions were not present in the same solution). In the calcium experiments, a solution of 400 mg calcium ions per L of solution were used as aqueous solution 202. In the cadmium experiments, a solution of 900 mg cadmium ions per L of solution were used as aqueous solution 202. The chelating gel 204 comprised ALP99VHM in the specified concentration (x-axis), with the fraction of each ion extracted given on the y-axis.

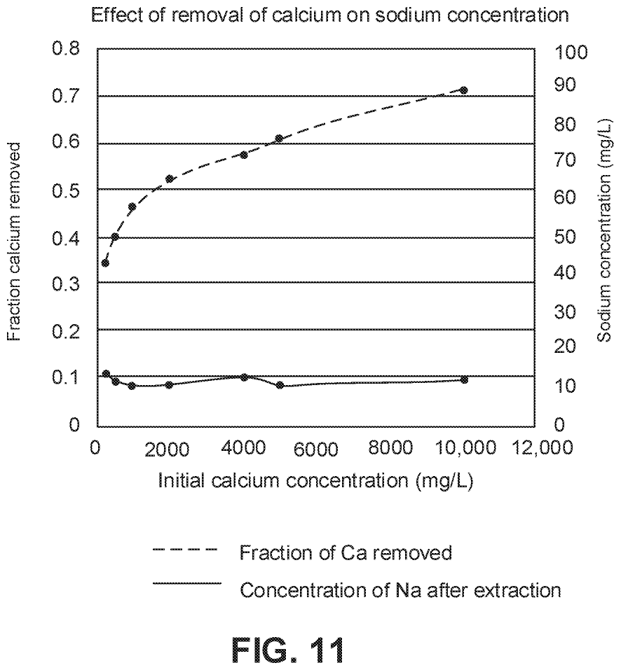

FIG. 11 follows the procedure as given under “methods,” with a calcium chloride solution used as the aqueous solution 202. The x-axis gives the initial mass of calcium ions per unit volume. The chelating gel 204 is ALP99VHM, which is known to contain a low concentration of sodium ions. The figure shows that the amount of sodium transferred from the polymer gel to the aqueous solution is uncorrelated with the calcium extraction, ruling out a Na⁺/Ca²⁺ ion exchange mechanism.

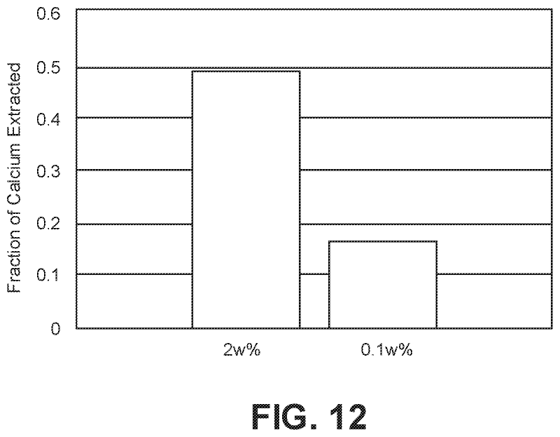

FIG. 12 shows a graph that compares the extraction of calcium conducted with a 0.1 w % solution (not gel) of ALP99VHM and a 2 w % gel of ALP99VHM. The method is as follows: A 0.1 w % solution of ALP99VHM and a 2 w % gel of ALP99VHM were prepared by dissolving a sample of the polymer in ultrapure water and stirring overnight. Twenty centimeter lengths of Spectra/Por 7 Dialysis Tubing (38 mm flat width, 1 kD MWCO) were prepared by soaking in ultrapure water for 10 minutes and subsequently rinsing to remove impurities. The tubes were then clamped shut at one end and loaded with 20 mL of either the 0.1 w % solution (serving in place of chelating gel 104) or the 2 w % gel (serving as chelating gel 104). The other end of the tube was then folded inward to eliminate surplus volume within the tube (i.e. make the volume of the tube match the volume of the solution or gel) and clamped shut. The sealed dialysis tubing then served as both the container for the solution or gel and the semipermeable membrane 106. The tubes were then placed in 150 mL of calcium chloride (aqueous solution 102) with a concentration of 1 g of calcium ions per liter of solution. After 22 hours, the tubes were removed and the aqueous solution analyzed. The results indicate substantially greater extraction from the aqueous phase by the gel system.

If the semi-permeable membrane is arranged in the form of a bag; the bag may be removed from the solution and the metal recovered; this represents a batch process for removal of metals. Alternatively, if the semi-permeable membrane is in the form of a tube that is run through the aqueous solution, the chelating gel may be run through the tube to remove metal from the aqueous phase in a continuous flow process. In some circumstances it may be desirable to flow the metal-containing aqueous solution through the tube immersed in a chelating agent-rich bath, but this is the same principle and leads to an equivalent continuous flow process.

The disclosed method is useful in a variety of different industrial environments including (1) food processing (removal of cations such as magnesium, sodium, and calcium from liquid food and beverage systems, removal of calcium ions from dairy products, use of the membrane to prevent contamination of the food product by the extraction agent is a major advantage to the technique) (2) waste water purification (removal of ions from industrial sources) (3) medical applications (modify dialysis machinery to treat heavy metal poisoning, creation of drop-in replacement filter for existing dialysis machines) (4) water desalination (removal of sodium, potassium, and other weakly-coordinating ions that create a challenge for desalination).

Further applications include (1) emergency spill response (apparatus could be delivered to site by truck, maneuvered into place by hand or with minimal machine support, and trucked out again on completion) (2) simultaneously neutralizes solution and removes harmful metals (3) mine waste remediation (old hard rock mines worldwide are flooded, and the water is often both metal-contaminated and acidic).

Methods

In FIGS. 6-11, the following procedure was carried out, except as noted differently in each case: A PUR-A-LYZER™ container (serving as container 201) equipped with a MIDI 3500 semi-permeable membrane (serving as semi-permeable membrane 206) was filled with ultrapure water and allowed to sit for a minimum of 5 minutes before being drained. It was then filled with 0.7 g of a gel composed of 1 w % SNF ALP99VHM in ultrapure water (serving as chelating gel 204). It was then placed in a 40 mL solution of calcium chloride or cadmium chloride in ultrapure water (serving as aqueous solution 202). The system was allowed to stand for at least 22 hours.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for extracting ions from an aqueous solution without utilizing ion exchange; the system comprising:
a semi-permeable membrane comprising pores with an average diameter between 0.1 nm and 1000 nm;
an aqueous solution comprising a salt with ions, the aqueous solution being disposed on a first side of the semi-permeable membrane;
a chelating gel disposed on a second side of the semi-permeable membrane which is opposite the first side, wherein the chelating gel consists of water and between 1% and 6%, by weight, of an un-crosslinked polymer.

2. The system as recited in claim 1, wherein the un-crosslinked polymer has an average molecular weight that is greater than or equal to a minimum molecular weight given by:
minimum molecular weight≥1611×(D)^{1.724}
wherein D is the average diameter of the pores, in nanometers, of the semi-permeable membrane, and the minimum molecular weight is in Daltons.

3. The system as recited in claim 2, wherein the average molecular weight is at least 10 times the minimum molecular weight.

4. The system as recited in claim 1, wherein the salt is a calcium salt.

5. The system as recited in claim 1, wherein the salt is a cadmium salt.

6. The system as recited in claim 1, wherein the chelating gel is ion-free.

7. The system as recited in claim 1, wherein the chelating gel is a polyacrylamide gel.

8. The system as recited in claim 1, wherein the chelating gel has a minimum viscosity of 10,000 centipoise.

9. A method for extracting ions from an aqueous solution without utilizing ion exchange; the method comprising:
disposing an aqueous solution on a first side of a semi-permeable membrane, the aqueous solution comprising a salt with ions;
disposing a chelating gel on a second side of the semi-permeable membrane which is opposite the first side, wherein the chelating gel consists of water and between 1% and 6%, by weight, of an un-crosslinked polymer;
waiting a predetermined period of time to permit at least some of the ions to pass through the semi-permeable membrane and become entrapped within the chelating gel;
separating the chelating gel from the semi-permeable membrane, thereby extracting the ions.

10. The method as recited in claim 9, wherein the salt is a calcium salt.

11. The method as recited in claim 9, wherein the salt is a cadmium salt.

12. The method as recited in claim 9, wherein the polymer gel comprises between 1% and 6%, by weight, of a polymer and between 94% and 99%, by weight, water.

13. The method as recited in claim 9, wherein the polymer is a polymer with a Lewis base substituent.

14. The method as recited in claim 9, wherein the polymer is selected from a group consisting of a polyacrylamide, a polycarbonate and a polyvinyl acetate.

15. The method as recited in claim 9, wherein the polymer is selected from a group consisting of a polyacrylic acid and a polysaccharide.

16. The method as recited in claim 9, wherein the polymer is a polyacrylamide.

17. The method as recited in claim 9, wherein the predetermined time is at least 10 hours but less than 48 hours.

18. The method as recited in claim 9, wherein the chelating gel has a minimum viscosity of 10,000 centipoise during the step of waiting.
